(19) United States
(12) Patent Application Publication
(10) Pub. No.: US 2016/0232559 A1
(43) Pub. Date: Aug. 11, 2016

(54) COUPON INFORMATION MANAGEMENT DEVICE, COUPON INFORMATION MANAGEMENT METHOD, AND PROGRAM

(71) Applicant: NEC CORPORATION, Tokyo (JP)

(72) Inventors: Hiroshi TEZUKA, Tokyo (JP); Masaharu KURODA, Tokyo (JP)

(73) Assignee: NEC CORPORATION, Tokyo (JP)

(21) Appl. No.: 15/021,738

(22) PCT Filed: Aug. 12, 2014
(86) PCT No.: PCT/JP2014/071269

§ 371 Date: Mar. 14, 2016

(30) Foreign Application Priority Data
Sep. 27, 2013 (JP) 2013-200759

(51) Int. Cl. G06Q 30/02

(52) U.S. Cl. CPC G06Q 30/0236; G06Q 30/0224

(57) ABSTRACT

A coupon information management device (10) includes: a visit estimation unit (110) that estimates a visit of a customer, which is identified by acquired customer identification information, to a store based on the acquired customer identification information; an available coupon specifying unit (120) that specifies a coupon available by the customer estimated to be in a visiting state by the visit estimation unit (110), from a storage unit (200) that stores a correspondence relationship between the customer identification information and coupon information, based on the acquired customer identification information; and a non-use determination unit (130) that detects that the specified available coupon has not been used by the customer.

### TECHNICAL FIELD

The present invention relates to a coupon information management device, a coupon information management method, and a program.

### BACKGROUND ART

A POS system that implements a POS register function using a general-purpose portable terminal, such as a tablet computer (PC), instead of a conventional point of sale (POS) register terminal has been provided. This is also referred to as a mobile POS system. According to this mobile POS system, advantages are provided that not only can the introduction cost be reduced, but also the administrator on the store side can perform sales management, sales analysis, or the like without depending on the location or time by linking with cloud services.

On the other hand, various electronic coupon services for attracting customers or for sales promotion have been provided. The following electronic coupon system has been proposed in the following Patent Document 1. A portable information terminal transmits a customer ID read from a customer card and its own portable information terminal ID to a store server at the time of a visit, and the store server associates the customer ID and the portable information terminal ID with each other. A store information terminal transmits the read customer ID, its own store information terminal ID, and the content ID of a target of a coupon, which is being displayed, to the store server by holding the customer card, and the store server provides coupon information, which is acquired from the coupon information database based on the content ID, to the portable information terminal associated with the customer ID.

### RELATED DOCUMENT

### Patent Document

[Patent Document 1] Japanese Unexamined Patent Publication NO. 2007-213276

### SUMMARY OF THE INVENTION

In the above-described Patent Document 1, however, the actual usage situation of coupons, such as how many coupons have been used in a state that a customer is capable of using a coupon, is not managed. That is, in Patent Document 1, it can be said that information to attract customers is buried in the actual usage situation of coupons. For example, information such as “even though a customer was in a situation in which a certain coupon was available, the customer did not use the coupon” can be one of the pieces of useful information for planning a strategy to attract more customers.

The present invention has been made in view of the aforementioned problem, and an object thereof is to provide a coupon information management device, a coupon information management method, and a program capable of checking the actual usage situation of a coupon in more detail.

According to the present invention, there is provided a coupon information management device including: a visit estimation unit that estimates a visit of a customer, which is identified by acquired customer identification information, to a store based on the acquired customer identification information; an available coupon specifying unit that specifies a coupon available by the customer estimated to be in a visiting state by the visit estimation unit, from a storage unit that stores a correspondence relationship between the customer identification information and coupon information, based on the acquired customer identification information; and a non-use determination unit that detects that the specified available coupon has not been used by the customer.

According to the present invention, there is provided a coupon information management method causing a computer to execute: visit estimation processing for estimating a visit of a customer, which is identified by acquired customer identification information, to a store based on the acquired customer identification information; available coupon specification processing for specifying a coupon available by the customer estimated to be in a visiting state by the visit estimation unit, from a storage unit that stores a correspondence relationship between the customer identification information and coupon information, based on the acquired customer identification information; and non-use determination processing for detecting that the specified available coupon has not been used by the customer.

According to the present invention, there is provided a program causing a computer to function as: a visit estimation unit that estimates a visit of a customer, which is identified by acquired customer identification information, to a store based on the acquired customer identification information; an available coupon specifying unit that specifies a coupon available by the customer estimated to be in a visiting state by the visit estimation unit, from a storage unit that stores a correspondence relationship between the customer identification information and coupon information, based on the acquired customer identification information; and a non-use determination unit that detects that the specified available coupon has not been used by the customer.

According to the present invention, the actual usage situation of a coupon can be checked in more detail.

### BRIEF DESCRIPTION OF THE DRAWINGS

The above-described object and other objects, features, and advantages will become more apparent by preferred embodiments described below and the following accompanying diagrams.

FIG. 1 is a block diagram illustrating a process configuration example of a coupon information management device in a first embodiment.

FIG. 2 is a diagram conceptually illustrating an example of the configuration of a mobile POS system in the present invention.

FIG. 3 is a diagram conceptually illustrating an example of the hardware configuration of the coupon information management device.

FIG. 4 is a flowchart illustrating the flow of the process of the coupon information management device in the first embodiment.

FIG. 5 is a block diagram illustrating a process configuration example of a coupon information management device in a second embodiment.

FIG. 6 is a flowchart illustrating the flow of the process of the coupon information management device in the second embodiment.

FIG. 7 is a flowchart illustrating the flow of the process of a coupon information management device in a modification example of the second embodiment.

### DESCRIPTION OF EMBODIMENTS

Hereinafter, an embodiment of the present invention will be described with reference to the accompanying diagrams. In addition, the same components are denoted by the same reference numerals in all drawings, and the explanation thereof will not be repeated.

### First Embodiment

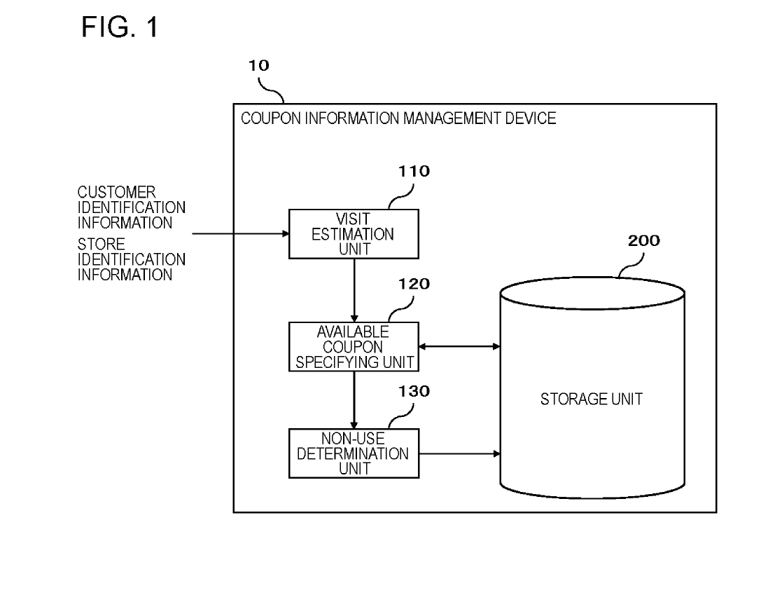

FIG. 1 is a block diagram illustrating a process configuration example of a coupon information management device 10 in a first embodiment. In FIG. 1, the coupon information management device 10 is a device that manages information regarding a coupon available in each store, and includes a visit estimation unit 110, an available coupon specifying unit 120, and a non-use determination unit 130. The coupon managed by the coupon information management device 10 may be an electronic coupon, or may be a non-electronic coupon. In addition, the coupon managed by the coupon information management device 10 indicates a broad concept that means exchange information for giving some benefits to the customer. Forms of the benefits given to the customer by the coupon are not limited. For example, the benefits given to the customer by the coupon are diverse including discounts on goods or services, exchange of goods or services, and granting of a privilege for goods or services.

In FIG. 1, the coupon information management device 10 further includes a storage unit 200. Although the example in which the coupon information management device 10 includes the storage unit 200 is shown in FIG. 1, other devices that can communicate with the coupon information management device 10 may include the storage unit 200.

The storage unit 200 stores the information of coupons (coupon information) managed in the coupon information management device 10. Coupon information includes at least a coupon identifier for identifying each coupon. Other pieces of information regarding each coupon, such as the effect of the coupon (discount rate, discount amount, or the like) or a use period, may be included in the coupon information. In addition, the storage unit 200 stores a correspondence relationship among customer identification information, store identification information, and coupon information corresponding to each coupon. Specifically, available store information (store identification information) indicating a store where the coupon is available is associated with the coupon information. The available store information may be included in the coupon information, or may be separately stored so as to be searchable using the coupon identifier of each coupon as a primary key. In addition, available customer information indicating a customer who can use the coupon (customer identification information) is associated with the coupon information. The available customer information may be included in the coupon information, or may be separately stored so as to be searchable using the coupon identifier of each coupon as a primary key. In addition, the storage unit 200 may store, for each customer, classified coupons that each customer can use.

The visit estimation unit 110 acquires the customer identification information and the store identification information, and estimates the visit of the customer identified by the customer identification information to the store identified by the store identification information based on the acquired customer identification information and store identification information. Here, the customer identification information is information that can uniquely identify an optional customer, such as a customer ID. The store identification information is information that can uniquely identify an optional store, such as a store ID.

Hereinafter, how the visit estimation unit 110 estimates the visit of a customer is illustrated. The method described below does not limit the embodiment of the present invention.

As an example, by acquiring “usage declaration information” from a terminal owned by a customer (customer terminal) or a terminal (for example, a customer-available terminal installed in a store) other than the customer terminal, the visit estimation unit 110 can estimate whether or not the customer is in a visiting state in a certain store.

The “usage declaration information” is information indicating that the customer has an intention to use the coupon. The usage declaration information is generated based on an input from the customer terminal, for example. Specifically, a customer selects or inputs a coupon, which needs to be used, in the customer terminal or the like, and usage declaration information including coupon information corresponding to the selected or input coupon is generated. Then, the generated usage declaration information is transmitted to the visit estimation unit 110. In this case, the visit estimation unit 110 can also acquire the customer identification information from the customer terminal. Specifically, the visit estimation unit 110 can acquire a customer identification number by making the customer input the customer identification number, such as the customer ID, together with a coupon that needs to be used. When the usage declaration information is generated using a customer terminal, by acquiring information unique to the customer terminal, such as the serial number of the customer terminal, and transmitting the information together with the usage declaration information, the visit estimation unit 110 can acquire the customer identification information. If the correspondence relationship between the customer identification number and the customer is stored in advance in the storage unit 200, the visit estimation unit 110 can specify the customer corresponding to the acquired customer identification number using the correspondence relationship.

Here, when the customer makes a usage declaration of a coupon, the customer is likely to visit a store where the use-declared coupon is available. Accordingly, the visit estimation unit 110 can estimate the store where the use-declared coupon is available, as a store being visited by the customer, using the usage declaration information. Specifically, the visit estimation unit 110 specifies coupon information corresponding to the coupon information included in the usage declaration information from the coupon information stored in the storage unit 200. Then, a store where the coupon is available is specified based on the available store information associated with the specified coupon information. When there is a plurality of stores corresponding to the use-declared coupon (for example, a coupon available in common in chain stores), for example, using position information of the customer acquired by a global positioning system (GPS) or the like, the visit estimation unit 110 can estimate a store closest to the position information as a store being visited by the customer.

As another example, the visit estimation unit 110 can acquire the position information of the customer and estimate a store, which is present in a predetermined range from the acquired position information, as a store being visited by the customer. For example, the visit estimation unit 110 can acquire position information obtained by the check-in function of the social networking service (SNS) as the position information of the customer. For the position information, for example, the GPS or position information of the customer terminal obtained by the access point of the wireless local area network (LAN) can also be acquired as the position information of the customer. When a store located within a predetermined range from the position information acquired as described above is present, the visit estimation unit 110 can estimate the store as a store being visited by the customer. When a plurality of stores are present in a “predetermined range”, the visit estimation unit 110 can estimate a store closest to the acquired position information as a store being visited by the customer.

In addition, the visit estimation unit 110 can also estimate the visit of the customer based on information obtained by using Shopkick (registered trademark) or the like. According to Shopkick (registered trademark), when there is a customer in a store where a device used in Shopkick (registered trademark) is installed, a response signal from the customer terminal is transmitted with respect to the ultrasonic wave transmitted from the device used in Shopkick (registered trademark). When the response signal with respect to the ultrasonic wave is detected, the visit estimation unit 110 can estimate that the customer corresponding to the customer terminal, which has transmitted the response signal, has visited the store.

Using the customer identification information and the store identification information acquired by the visit estimation unit 110, the available coupon specifying unit 120 specifies a coupon available by the customer estimated to be in a visiting state in the store which is estimated to be being visited by the customer by the visit estimation unit 110, from the storage unit 200.

Specifically, the available coupon specifying unit 120 can specify a coupon, which is available in the store estimated to be being visited by the customer by the visit estimation unit 110, by comparing the store identification information acquired by the visit estimation unit 110 with the available store information associated with each piece of coupon information stored in the storage unit 200. The available coupon specifying unit 120 can specify a coupon, which is available by the customer estimated to be in a visiting state by the visit estimation unit 110, by comparing the customer identification information acquired by the visit estimation unit 110 with the available customer information associated with each piece of coupon information stored in the storage unit 200.

The non-use determination unit 130 detects that each available coupon specified by the available coupon specifying unit 120 has not been used by the customer identified based on the customer identification information acquired by the visit estimation unit 110. The detection result of the non-use determination unit 130 is stored in the storage unit 200 as a usage situation corresponding to the coupon information of the target.

The usage situation of coupons is information associated with the coupon information stored in the storage unit 200. The usage situation includes at least three states of “used state”, “first unused state”, and “second unused state”. The “used state” indicates a state in which the coupon information was already used. The “first unused state” indicates a state in which a customer did not use a coupon even though the customer was in a situation in which the coupon was available. The “second unused state” indicates a state in which a customer did not use a coupon since the customer was not in a situation in which the coupon was available. The usage situation may be included in the coupon information, or may be separately stored so as to be searchable using the coupon identifier of each coupon as a primary key. In the initial state, the usage situation associated with the coupon information is set to the “second unused state”.

As will be described later, when it is determined that the customer visited the store and the coupon was available but the customer did not use the coupon, the non-use determination unit 130 determines the usage situation of the coupon to be the “first unused state”, and sets the usage situation associated with coupon information corresponding to the coupon to be the “first unused state”. In addition, when the customer has used the coupon, the non-use determination unit 130 determines the usage situation of the coupon to be the “used state”, and sets the usage situation associated with coupon information corresponding to the coupon to be the “used state”.

Hereinafter, how the non-use determination unit 130 determines that a coupon has not been used is illustrated. The method described below does not limit the embodiment of the present invention.

As an example, the non-use determination unit 130 can determine whether or not the usage situation of a coupon included in the usage declaration information is the “first unused state” using the usage declaration information. Specifically, when a predetermined time has passed from the acquisition of the usage declaration information, the non-use determination unit 130 can determine that the coupon included in the usage declaration has not been used. The predetermined time is preferably set to an appropriate value for each store. For example, an average time for which the customer stays in the store, an average time until payment from the visit of the customer, or the like can be counted, and the value can be set as the predetermined time.

As another example, when the usage situation of at least one coupon out of the coupons specified by the available coupon specifying unit 120 is set to the “used state”, the non-use determination unit 130 can determine the usage situation of a coupon other than the coupons set to the “used state”, among the coupons specified by the available coupon specifying unit 120, to be the first unused state. Here, the non-use determination unit 130 can determine whether or not the usage situation of the coupon has been set to the “used state” by using the notification of use, for example. Here, the “notification of use” is information for notifying of a used coupon among the coupons specified by the available coupon specifying unit 120. For example, the notification of use is generated, during or after adjustment including the use of a coupon, by acquiring coupon information indicating the coupon in the cash register terminal on the store side. The generated notification of use is transmitted to the coupon information management device 10, and the non-use determination unit 130 can determine the usage situation of the coupon specified by the available coupon specifying unit 120 based on the received notification of use. Other devices excluding the coupon information management device 10 may acquire the notification of use, and the usage situation of the used coupon may be reflected in the storage unit 200. In this case, the coupon information management device 10 determines whether or not the usage situation of at least one coupon out of the coupons specified by the available coupon specifying unit 120 is set to the “used state” using the usage situation reflected by the other devices.

If the coupon information management device 10 further includes a leaving information acquisition unit (not shown) that acquires leaving information indicating that the customer has left the store, the non-use determination unit 130 can determine that the coupon has not been used based on the acquired leaving information. Specifically, if the usage situation associated with the coupon specified by the available coupon specifying unit 120 is not updated to the “used state” until the leaving information of a certain customer is acquired, the non-use determination unit 130 can determine that the coupon has not been used in a state in which the coupon is available. The leaving information can be determined based on the position information of the customer obtained from, for example, the GPS or the check-in information on the SNS, or can be determined based on the presence of a response signal from the customer terminal in Shopkick (registered trademark).

[System Configuration]

Hereinafter, a mobile POS system including the coupon information management device 10 is illustrated. However, the content of the above embodiment and each embodiment to be described below is not only applicable to the mobile POS system and can be applied to any system that provides a service using a coupon.

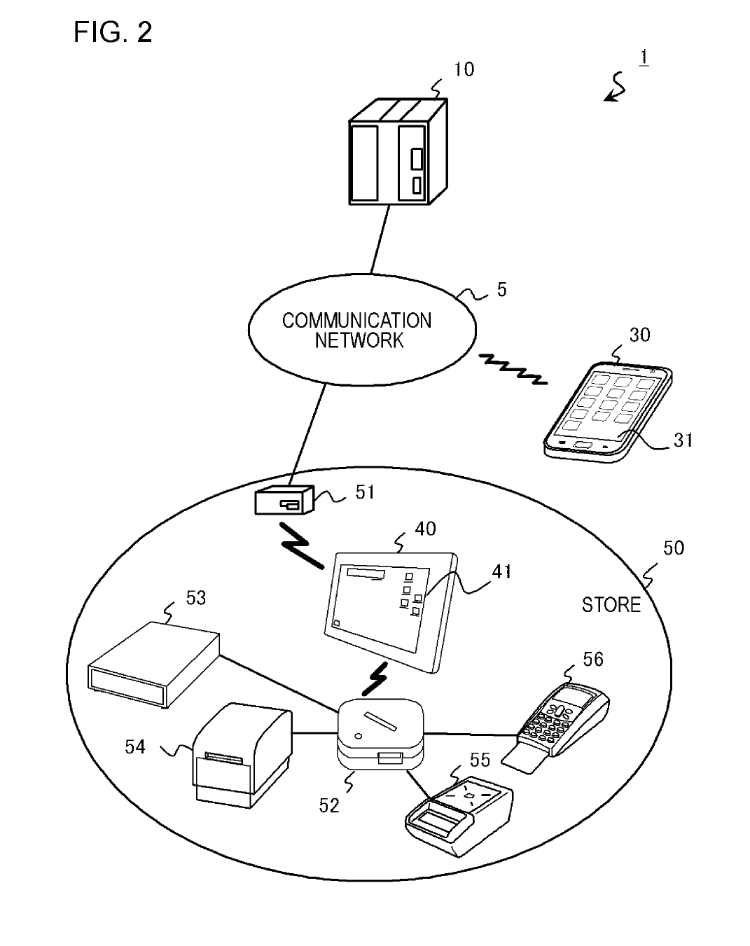

FIG. 2 is a diagram conceptually illustrating an example of the configuration of a mobile POS system (hereinafter, abbreviated as a POS system) 1 in the present invention.

The POS system 1 is configured to include the coupon information management device 10, a portable information terminal 30, and a store side configuration 50. The POS system 1 provides an electronic coupon service for a customer using the portable information terminal 30, and provides POS service for a store in which the store side configuration 50 is used. The portable information terminal 30 can also be referred to as the customer terminal 30.

The coupon information management device 10 and the store side configuration 50 are communicably connected to each other through a communication network 5. The communication network 5 is formed by at least one of various forms of communication networks, such as public networks including the Internet, a wide area network (WAN), a local area network (LAN), a communication carrier network, and a wireless communication network. The implementation of the communication network 5 is not limited.

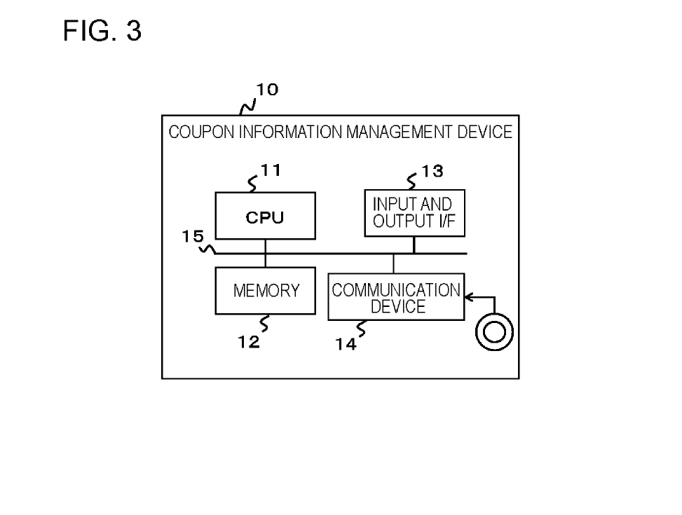

FIG. 3 is a diagram conceptually illustrating an example of the hardware configuration of the coupon information management device 10. The coupon information management device 10 is a so-called computer, and includes a central processing unit (CPU) 11, a memory 12, an input and output interface (I/F) 13, a communication device 14, and the like that are connected to each other by a bus 15, for example. The memory 12 is a random access memory (RAM), a read only memory (ROM), a hard disk, or the like. The communication device 14 communicates with other computers or other devices. A portable recording medium or the like may be connected to the communication device 14.

The input and output interface (I/F) 13 can be connected to user interface devices (not shown), such as a display device and an input device. The display device is a device that displays a screen corresponding to drawing data processed by the CPU 11, a graphics processing unit (GPU; not shown), or the like, such as a liquid crystal display (LCD) or a cathode ray tube (CRT) display. The input device is a device for receiving the input of a user operation, such as a keyboard or a mouse. However, neither a display device nor an input device may be connected to the input and output I/F 13. The hardware configuration of the coupon information management device 10 is not limited.

Each processing unit of the coupon information management device 10 described previously is implemented, for example, by the execution of a program stored in the memory 12 by the CPU 11. For example, the program may be installed through the input and output I/F 13 from a portable recording medium, such as a compact disc (CD) or a memory card, or other computers on the network, and may be stored in the memory 12.

The customer terminal 30 is a so-called a portable computer, such as a personal computer (PC), a mobile phone, a smartphone, or a tablet terminal. For example, the customer terminal 30 has a hardware configuration shown in FIGS. 2 and 3. According to the example shown in FIG. 2, the customer terminal 30 has, as a user interface device, a touch panel unit 31 including a display unit and a touch sensor. The display unit includes a monitor, such as a liquid crystal display (LCD) or a cathode ray tube (CRT) display, and performs display processing. A touch sensor receives an operation input from the user by sensing contact from the outside or the proximity state. However, the hardware configuration of the customer terminal 30 is not limited. For example, the user interface device of the customer terminal 30 may be a mechanical keyboard.

The store side configuration 50 includes a communication relay device 51, a store terminal 40, a stand 52, a cash drawer 53, a receipt printer 54, an electronic money reader and writer 55, and a credit card reader and writer 56. The stand 52 is a device for communicably connecting the store terminal 40 and other devices (the cash drawer 53, the receipt printer 54, the electronic money reader and writer 55, the credit card reader and writer 56, and the like) to each other. The store terminal 40 and the stand 52 are connected to each other, for example, by Bluetooth (registered trademark), short-range wireless communication such as infrared communication, wireless communication such as wireless LAN, or cable communication such as a universal serial bus (USB). The stand 52 and other devices are connected to each other by various communication lines or wirelessly. The communication relay device 51 connects the store terminal 40 to the communication network 5 so that communication between the store terminal 40 and the coupon information management device 10 is possible. In addition, the form of communication between these nodes is not limited. The store terminal 40 may be connected to the communication network 5 using the 3G network through a wireless base station or the like without passing through the communication relay device 51. The cash drawer 53, the receipt printer 54, the electronic money reader and writer 55, and the credit card reader and writer 56 correspond to part devices included in a general POS register device.

The store terminal 40 is the same portable computer as the customer terminal 30. The store terminal 40 may be the same stationary general-purpose computer as the coupon information management device 10. For example, the store terminal 40 has a hardware configuration shown in FIGS. 2 and 3. According to the example shown in FIG. 2, the store terminal 40 has, as a user interface device, a touch panel unit 41 including a display unit and a touch sensor. However, the hardware configuration of the store terminal 40 is not limited. For example, the user interface device of the store terminal 40 may be a mechanical keyboard.

### Operation Example

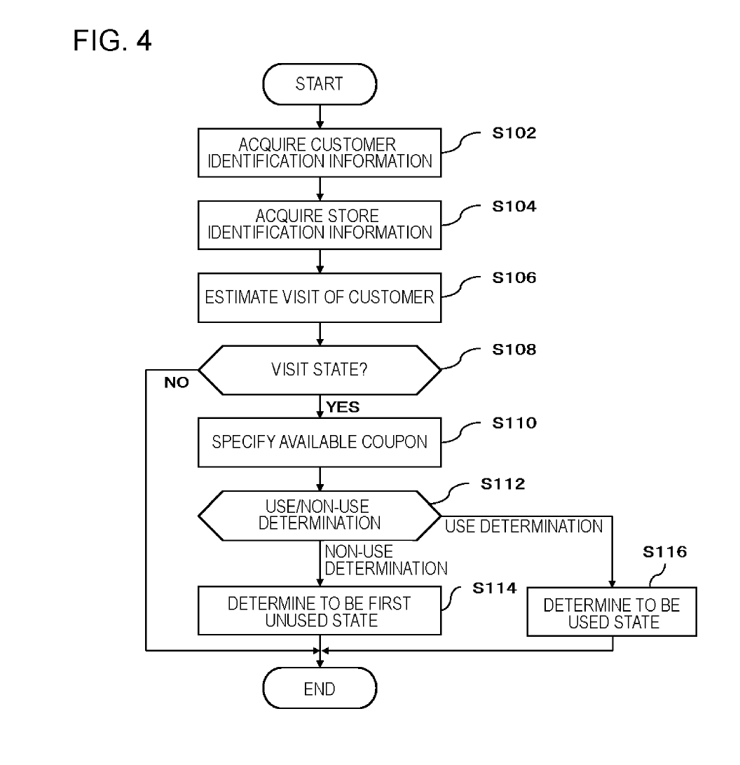

An operation example of the coupon information management device 10 in the present embodiment will be described with reference to FIG. 4. FIG. 4 is a flowchart illustrating the flow of the process of the coupon information management device 10 in the first embodiment.

The coupon information management device 10 acquires customer identification information (S102). In addition, the coupon information management device 10 acquires store identification information (S104). Then, the coupon information management device 10 estimates the visit of a customer corresponding to the customer identification information acquired in S102 to the store corresponding to the store identification information acquired in S104 (S106). When it is not estimated that the customer is in a visiting state (S108: NO), the coupon information management device 10 ends the process. On the other hand, when it is estimated that the customer is in a visiting state (S108: YES), the coupon information management device 10 specifies a coupon that the customer corresponding to the customer identification information acquired in S102 can use in the store corresponding to the store identification information acquired in S104 (S110). Then, the coupon information management device 10 determines the use/non-use of the coupon corresponding to the available coupon information specified in S110 (S112). When it is determined that the available coupon specified in S110 has not been used (S112: non-use determination), the coupon information management device 10 determines the coupon specified in S110 to be a “state in which the customer did not use the coupon even though the customer was in a situation in which the coupon was available”, that is, “first unused state” (S114), and stores the determination result in the storage unit 200. On the other hand, when it is determined that the available coupon specified in S110 has been used (S112: use determination), the coupon information management device 10 determines the coupon specified in S110 to be the “used state” (S116), and stores the determination result in the storage unit 200.

Then, in response to an instruction transmitted from the input device or the store terminal 40 connected to the coupon information management device 10, the coupon information management device 10 can present a usage situation in a state in which the coupon is available to the user on the store side by displaying the determination result stored in the storage unit 200 on a display device connected to the coupon information management device 10, a display unit of the store terminal 40, or the like.

As described above, according to the present embodiment, when the visit of a customer to the store is estimated and the customer is estimated to be in a visiting state, a coupon that the customer can use in the store is specified. Then, determination that the specified available coupon has not been used by the customer is made, and this is managed in the storage unit 200.

Specifically, when the specified available coupon was not used, the usage situation associated with the coupon is set to the “first unused state” indicating a state in which the customer did not use a coupon even though the customer was in a situation in which the coupon was available, and this is stored in the storage unit 200. In addition, the information stored in this manner is presented to the user on the store side through the display device or the like.

As described above, according to the present embodiment, “even though a customer had an available coupon, the customer did not use the coupon” can be reliably managed. Therefore, it is possible to extract the useful information that has been buried in the related art. In addition, by determining the effectiveness of each coupon accurately using the extracted information, it is possible to reflect the results in future strategies.

### Second Embodiment

The present embodiment is the same as the first embodiment except for the following points.

[Process Configuration]

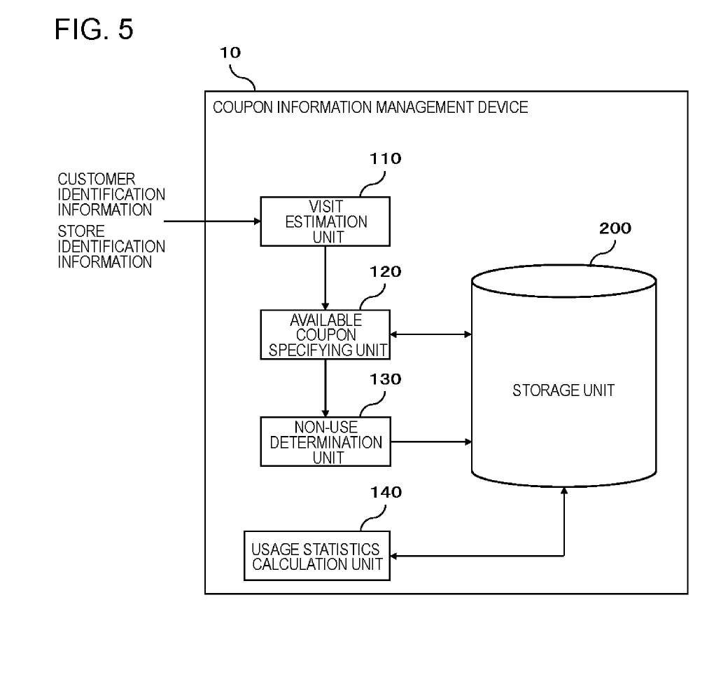

FIG. 5 is a block diagram illustrating a process configuration example of a coupon information management device 10 in a second embodiment. As shown in FIG. 2, the coupon information management device 10 of the present embodiment further includes a usage statistics calculation unit 140.

The usage statistics calculation unit 140 calculates the usage statistics of each coupon in a state in which each coupon is available using the statistics of the determination results of the non-use determination unit 130. Here, the “state in which each coupon is available” refers to a state in which it is estimated that a certain customer has visited a certain store and there is at least one coupon that the customer can use in the store. For example, the “usage statistics of each coupon” may be the number of times in which the coupon was used or the number of times in which the coupon was not used in a state in which the coupon was available, or may be the rate of use or the rate of non-use that is calculated based on these numbers of times and the number of times in which each coupon was available. The usage statistics is calculated for each coupon, and can be an index indicating the effectiveness of each coupon or the like.

The usage statistics calculation unit 140 may calculate all of the usage statistics up to date, or may calculate the usage statistics in a part of the period. For example, the usage statistics calculation unit 140 may calculate the usage statistics in a fixed period, such as several weeks or several months, for each coupon. In this case, the non-use determination unit 130 stores date and time information, which indicates the date and time when determination was performed, in association with the determination in the storage unit 200. The usage statistics calculation unit 140 can calculate the usage statistics in a fixed period using the date and time information associated with the determination result.

### Operation Example

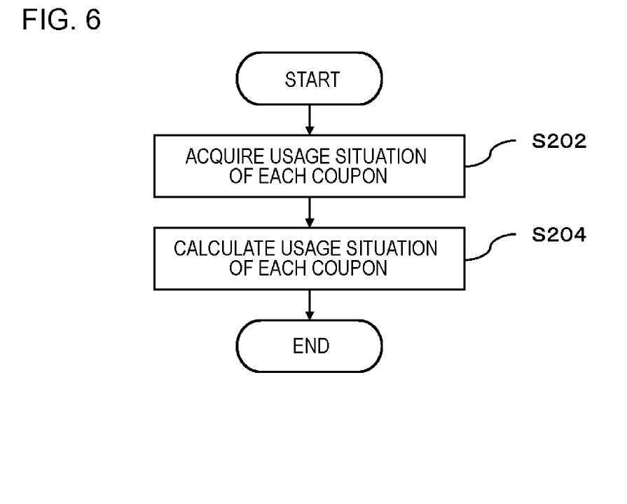

An operation example of the coupon information management device 10 in the present embodiment will be described with reference to FIG. 6. FIG. 6 is a flowchart illustrating the flow of the process of the coupon information management device 10 in the second embodiment.

The coupon information management device 10 acquires the usage situation of each coupon stored in the storage unit 200 (S202). In this case, the coupon information management device 10 may further receive conditions, such as a period for calculating the usage statistics or the type of a coupon for which determination results are acquired. In this case, the coupon information management device 10 acquires the determination result corresponding to the received conditions from the storage unit 200. Then, the coupon information management device 10 calculates the usage statistics of each coupon using the usage situation acquired in S202 (S204).

Then, in response to an instruction transmitted from the input device or the store terminal 40 connected to the coupon information management device 10, the coupon information management device 10 can present a usage situation in a state in which the coupon is available to the user on the store side in more detail than in the first embodiment by displaying the usage statistics of each coupon calculated by the usage statistics calculation unit 140 on a display device connected to the coupon information management device 10, a display unit of the store terminal 40, or the like.

As described above, in the present embodiment, the usage statistics of each coupon is calculated using the usage situation of the coupon stored in the storage unit 200. In addition, the usage statistics calculated in this manner are presented to the user on the store side through the display device or the like.

Therefore, according to the present embodiment, “even though a customer had an available coupon, the customer did not use the coupon” can be presented as more understandable usage statistics. In addition, by determining the effectiveness of each coupon more easily using the usage statistics, it is possible to reflect the results in future strategies.

In the present embodiment, the usage statistics for each fixed period can be calculated for each coupon. Therefore, according to the present embodiment, it is possible to calculate more detailed usage statistics, such as latest usage statistics of the coupon, usage statistics of the coupon for each season, or usage statistics of the coupon for each day of the week/time zone, for example. In addition, the detailed usage statistics can be used as information to establish a more effective strategy.

[Modification Example of the Second Embodiment]

In this modification example, customer attribute information is associated with customer identification information, and the non-use determination unit 130 further stores the customer attribute information associated with the customer identification information acquired by the visit estimation unit 110 in the storage unit 200 together with the usage situation. The customer attribute information can be acquired by receiving the input from the customer in advance, for example. The usage statistics calculation unit 140 classifies the determination results stored in the storage unit 200 for each piece of the customer attribute information based on the customer attribute information, and calculates more detailed usage statistics. Here, the “customer attribute information” is information regarding a customer, such as the customer's age, sex, or address, for example.

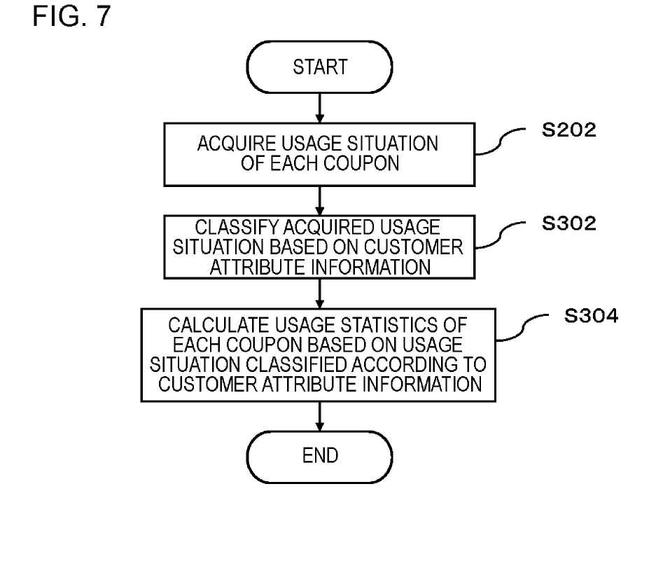

An operation example of the coupon information management device 10 in this modification example will be described with reference to FIG. 7. FIG. 7 is a flowchart illustrating the flow of the process of the coupon information management device 10 in the modification example of the second embodiment. Different steps (S302 to S304) from that of the second embodiment will be described below.

The coupon information management device 10 classifies the usage situation of each coupon acquired in S202 based on the customer attribute information that is stored so as to be associated with the usage situation (S302). Then, the coupon information management device 10 calculates the usage statistics of each coupon for each customer attribute based on the determination results classified according to the customer attribute information (S304). In addition, the conditions to classify the usage situation stored in the storage unit 200 can be appropriately changed by the user on the store side. For example, if the user instructs the coupon information management device 10 to classify the usage situation for each age, the usage statistics calculation unit 140 calculates the usage statistics of each coupon based on the usage situation classified based on “customer attribute information: age”. If the user instructs the coupon information management device 10 to classify the usage situation for each sex, the usage statistics calculation unit 140 calculates the usage statistics of each coupon based on the usage situation classified based on “customer attribute information: sex”.

As described above, also in this modification example, it is possible to obtain the same effect as in the second embodiment. In addition, in this modification example, the usage situation stored in the storage unit 200 is classified based on the customer attribute information, and the usage statistics of each coupon are calculated based on the classified determination result.

Thus, according to this modification example, it is possible to calculate more detailed usage statistics in accordance with the attributes of the customer. Accordingly, it is possible to obtain information to establish a more detailed strategy for each age or sex.

While the embodiments of the present invention have been described with reference to the diagrams, these are only illustration of the present invention, and other various configurations can also be adopted.

For example, in each of the embodiments described above, a form is assumed in which the coupon information management device 10 manages the coupon information of a plurality of stores. Therefore, in each of the embodiments described above, the coupon information management device 10 specifies a target store from the plurality of stores by further acquiring store identification information that can uniquely identify an optional store, such as a store ID. However, when the coupon information management device 10 is separately provided for each store, the store is already uniquely determined. Therefore, the coupon information management device 10 does not need to acquire store identification information.

In this case, the visit estimation unit 110 acquires at least customer identification information, and estimates the visit of the customer, which is identified by the customer identification information, to the store based on the acquired customer identification information. In addition, the storage unit 200 stores at least the correspondence relationship between the customer identification information and coupon information, and the available coupon specifying unit 120 specifies a coupon that the customer estimated to be in a visiting state by the visit estimation unit 110 can use, from the storage unit 200, based on the customer identification information acquired by the visit estimation unit 110.

In a plurality of flowcharts used in the above explanation, a plurality of steps (processes) are described in order. However, the execution order of the processes performed in each embodiment is not limited to the order of the explanation. In each embodiment, it is possible to change the order of the illustrated steps in a range in which no problem is caused in terms of the content. In addition, the respective embodiments described above can be combined in a range in which the content does not conflict.

Hereinafter, examples of reference forms are additionally written.

1. A coupon information management device including: a visit estimation unit that estimates a visit of a customer, which is identified by acquired customer identification information, to a store based on the acquired customer identification information; an available coupon specifying unit that specifies a coupon available by the customer estimated to be in a visiting state by the visit estimation unit, from a storage unit that stores a correspondence relationship between the customer identification information and coupon information, based on the acquired customer identification information; and a non-use determination unit that detects that the specified available coupon has not been used by the customer.

2. The coupon information management device described in 1 in which the storage unit further stores a usage situation of the coupon so as to be associated with the coupon information and in which the non-use determination unit sets the usage situation of the coupon specified by the available coupon specifying unit to a first unused state, between the first unused state indicating a state in which the customer did not use a coupon even though the customer was in a situation in which the coupon was available and a second unused state indicating a state in which the customer did not use a coupon since the customer was not in a situation in which the coupon was available, by the detection.

3. The coupon information management device described in 2 in which the non-use determination unit determines the usage situation of the coupon to be the first unused state when a predetermined time has passed from acquisition of usage declaration information indicating usage intention for at least one coupon out of coupons specified by the available coupon specifying unit.

4. The coupon information management device described in 2 or 3 in which, when the usage situation of at least one coupon out of coupons specified by the available coupon specifying unit is set to a used state indicating a state in which the customer used the coupon, the non-use determination unit determines a usage situation of a coupon other than the coupon set to the used state, among the coupons specified by the available coupon specifying unit, to be the first unused state.

5. The coupon information management device described in any one of 2 to 4 which further includes a leaving information acquisition unit that acquires leaving information indicating that the customer has left a store and in which, when the usage situation of the coupon specified by the available coupon specifying unit is not set to the used state indicating a state in which the customer used the coupon until the leaving information is acquired, the non-use determination unit determines the usage situation of the coupon to be the first unused state.

6. The coupon information management device described in any one of 1 to 5 in which the visit estimation unit estimates a store being visited by the customer using coupon information included in usage declaration information indicating usage intention for at least one coupon out of coupons available by the customer.

7. The coupon information management device described in any one of 1 to 6 in which the visit estimation unit acquires position information of the customer and estimates a store being visited by the customer using the acquired position information.

8. The coupon information management device described in any one of 1 to 7 which further includes a usage statistics calculation unit that calculates usage statistics of the coupon in a state in which the coupon is available, for each coupon, using statistics of results of the detection.

9. The coupon information management device described in 8 in which customer attribute information indicating attributes of the customer is associated with the customer identification information, the non-use determination unit stores the customer attribute information associated with the acquired customer identification information so as to be associated with the results of the detection, and the usage statistics calculation unit classifies the results of the detection using the customer attribute information associated with the results of the detection, and calculates the usage statistics of the coupon.

10. A coupon information management method causing a computer to execute: visit estimation processing for estimating a visit of a customer, which is identified by acquired customer identification information, to a store based on the acquired customer identification information; available coupon specification processing for specifying a coupon available by the customer estimated to be in a visiting state by the visit estimation unit, from a storage unit that stores a correspondence relationship between the customer identification information and coupon information, based on the acquired customer identification information; and non-use determination processing for detecting that the specified available coupon has not been used by the customer.

11. The coupon information management method described in 10 in which the storage unit further stores a usage situation of the coupon so as to be associated with the coupon information and in which the computer sets the usage situation of the coupon specified by the available coupon specification processing to a first unused state, between the first unused state indicating a state in which the customer did not use a coupon even though the customer was in a situation in which the coupon was available and a second unused state indicating a state in which the customer did not use a coupon since the customer was not in a situation in which the coupon was available, by the detection.

12. The coupon information management method described in 11 in which the computer determines the usage situation of the coupon to be the first unused state when a predetermined time has passed from acquisition of usage declaration information indicating usage intention for at least one coupon out of coupons specified by the available coupon specification processing.

13. The coupon information management method described in 11 or 12 in which, when the usage situation of at least one coupon out of coupons specified by the available coupon specifying unit is set to a used state indicating a state in which the customer used the coupon, the computer determines a usage situation of a coupon other than the coupon set to the used state, among the coupons specified by the available coupon specifying unit, to be the first unused state.

14. The coupon information management method described in any one of 11 to 13 in which the computer further executes leaving information acquisition processing for acquiring leaving information indicating that the customer has left a store and in which, when the usage situation of the coupon specified by the available coupon specification processing is not set to the used state indicating a state in which the customer used the coupon until the leaving information is acquired, the computer determines the usage situation of the coupon to be the first unused state.

15. The coupon information management method described in any one of 11 to 14 in which the computer estimates a store being visited by the customer using coupon information included in usage declaration information indicating usage intention for at least one coupon out of coupons available by the customer.

16. The coupon information management method described in any one of 11 to 15 in which the computer acquires position information of the customer and estimates a store being visited by the customer using the acquired position information.

17. The coupon information management method described in any one of 11 to 16 in which the computer further executes usage statistics calculation processing for calculating usage statistics of the coupon in a state in which the coupon is available, for each coupon, using statistics of results of the detection.

18. The coupon information management method described in 17 in which customer attribute information indicating attributes of the customer is associated with the customer identification information, the computer stores the customer attribute information associated with the acquired customer identification information in the storage unit so as to be associated with the results of the detection, and the computer classifies the results of the detection using the customer attribute information associated with the results of the detection, and calculates the usage statistics of the coupon.

19. A program causing a computer to function as: a visit estimation unit that estimates a visit of a customer, which is identified by acquired customer identification information, to a store based on the acquired customer identification information; an available coupon specifying unit that specifies a coupon available by the customer estimated to be in a visiting state by the visit estimation unit, from a storage unit that stores a correspondence relationship between the customer identification information and coupon information, based on the acquired customer identification information; and a non-use determination unit that detects that the specified available coupon has not been used by the customer.

20. The program described in 19 in which the storage unit further stores a usage situation of the coupon so as to be associated with the coupon information and in which the non-use determination unit sets the usage situation of the coupon specified by the available coupon specifying unit to a first unused state, between the first unused state indicating a state in which the customer did not use a coupon even though the customer was in a situation in which the coupon was available and a second unused state indicating a state in which the customer did not use a coupon since the customer was not in a situation in which the coupon was available, by the detection.

21. The program described in 20 in which the non-use determination unit determines the usage situation of the coupon to be the first unused state when a predetermined time has passed from acquisition of usage declaration information indicating usage intention for at least one coupon out of coupons specified by the available coupon specifying unit.

22. The program described in 20 or 21 in which, when the usage situation of at least one coupon out of coupons specified by the available coupon specifying unit is set to a used state indicating a state in which the customer used the coupon, the non-use determination unit determines a usage situation of a coupon other than the coupon set to the used state, among the coupons specified by the available coupon specifying unit, to be the first unused state.

23. The program described in any one of 20 to 22 in which a leaving information acquisition unit that acquires leaving information indicating that the customer has left a store is further included and in which, when the usage situation of the coupon specified by the available coupon specifying unit is not set to the used state indicating a state in which the customer used the coupon until the leaving information is acquired, the non-use determination unit determines the coupon to be a coupon in the first unused state.

24. The program described in any one of 19 to 23 in which the visit estimation unit estimates a store being visited by the customer using coupon information included in usage declaration information indicating usage intention for at least one coupon out of coupons available by the customer.

25. The program described in any one of 19 to 24 in which the visit estimation unit acquires position information of the customer and estimates a store being visited by the customer using the acquired position information.

26. The program described in any one of 19 to 25 in which a usage statistics calculation unit that calculates usage statistics of the coupon in a state in which the coupon is available, for each coupon, using statistics of results of the detection is further included.

27. The program described in 26 in which customer attribute information indicating attributes of the customer is associated with the customer identification information, the non-use determination unit stores the customer attribute information associated with the customer identification information in the storage unit so as to be associated with the results of the detection, and the usage statistics calculation unit classifies the results of the detection using the customer attribute information associated with the results of the detection, and calculates the usage statistics of the coupon.

This application claims priority from Japanese Patent Application No. 2013-200759, filed on Sep. 27, 2013, the entire contents of which are incorporated herein.

1. A coupon information management device comprising at least one processor, the processor:
estimating a visit of a customer, which is identified by acquired customer identification information, to a store based on the acquired customer identification information,
specifying a coupon available by the customer estimated to be in a visiting state by the visit estimation unit, from a storage unit that stores a correspondence relationship between the customer identification information and coupon information, based on the acquired customer identification information, and
detecting that the specified available coupon has not been used by the customer.

2. The coupon information management device according to claim 1,
wherein the storage unit further stores a usage situation of the coupon so as to be associated with the coupon information, and
the processor sets the usage situation of the coupon specified by the processor to a first unused state, between the first unused state indicating a state in which the customer did not use a coupon even though the customer was in a situation in which the coupon was available and a second unused state indicating a state in which the customer did not use a coupon since the customer was not in a situation in which the coupon was available, by the detection.

3. The coupon information management device according to claim 2,
wherein the processor determines the usage situation of the coupon to be the first unused state when a predetermined time has passed from acquisition of usage declaration information indicating usage intention for at least one coupon out of coupons specified by the processor.

4. The coupon information management device according to claim 2,
wherein, when the usage situation of at least one coupon out of coupons specified by the processor is set to a used state indicating a state in which the customer used the coupon, the processor determines a usage situation of a coupon other than the coupon set to the used state, among the coupons specified by the processor, to be the first unused state.

5. The coupon information management device according to claim 2,
the processor further acquires leaving information indicating that the customer has left a store,
wherein, when the usage situation of the coupon specified by the processor is not set to the used state indicating a state in which the customer used the coupon until the leaving information is acquired, the processor the usage situation of the coupon to be the first unused state.

6. The coupon information management device according to claim 1,
wherein the processor estimates a store being visited by the customer using coupon information included in usage declaration information indicating usage intention for at least one coupon out of coupons available by the customer.

7. The coupon information management device according to claim 1,
wherein the processor acquires position information of the customer, and estimates a store being visited by the customer using the acquired position information.

8. The coupon information management device according to claim 1,
the processor further calculates usage statistics of the coupon in a state in which the coupon is available, for each coupon, using statistics of results of the detection.

9. The coupon information management device according to claim 8,
wherein customer attribute information indicating attributes of the customer is associated with the customer identification information,
the processor stores the customer attribute information associated with the customer identification information in the storage unit so as to be associated with the results of the detection, and
the processor classifies the results of the detection using the customer attribute information associated with the results of the detection, and calculates the usage statistics of the coupon.

10. A coupon information management method causing a computer to execute:
visit estimation processing for estimating a visit of a customer, which is identified by acquired customer identification information, to a store based on the acquired customer identification information;
available coupon specification processing for specifying a coupon available by the customer estimated to be in a visiting state in the visit estimation processing, from a storage unit that stores a correspondence relationship between the customer identification information and coupon information, based on the acquired customer identification information; and
non-use determination processing for detecting that the specified available coupon has not been used by the customer.

11. A non-transitory computer readable medium storing a program causing a computer to function as:
a visit estimation unit that estimates a visit of a customer, which is identified by acquired customer identification information, to a store based on the acquired customer identification information;
an available coupon specifying unit that specifies a coupon available by the customer estimated to be in a visiting state by the visit estimation unit, from a storage unit that stores a correspondence relationship between the customer identification information and coupon information, based on the acquired customer identification information; and
a non-use determination unit that detects that the specified available coupon has not been used by the customer.
